(19) United States
(12) Patent Application Publication
(10) Pub. No.: US 2002/0110357 A1
(43) Pub. Date: Aug. 15, 2002

(54) Address coding method for data storage device

(76) Inventor: Kai Leung Fan, Hong Kong (HK)

Correspondence Address: Raymond Y.C. Chan, 516 San Luis Rey Road, Arcadia, CA, 91007, US

(21) Appl. No.: 09/740,074

(22) Filed: Dec. 18, 2000

(51) Int. Cl. H04N 5/91; H04N 5/90; H04N 5/781; H04N 5/85

(52) U.S. Cl. 386/65; 386/126

(57) ABSTRACT

A hexadecimal/binary-coded-decimal (HEXA-BCD) hybrid address coding method for representing digital timing address of data storage device, wherein the first digit of the minute filed is represented in Hexadecimal format with four binary data bits, therefore the 0-9 is the same as the BCD coding while 11-15 (A-F) is an extension which allows the proprietary recorder to recognize the data storage device and generates the time address for the digital data storage device. Furthermore, a slight fireware change is made by extending the address look up table to 159:59:74. Hence the first digit of the time address must be represented in Hexadecimal which fully utilizes the four addressing bits in the M1 frame.

### BACKGROUND OF THE PRESENT INVENTION

1. Field of the Present Invention

The present invention relates to address coding of data storage device, and more particularly to a hexadecimal/binary-coded-decimal (HEXA-BCD) hybrid address coding method for representing digital timing address, such as audio/visual data addressing, of data storage device like recordable compact disc, rewritable compact disc, video tape and etc.

2. Description of Related Arts

The conventional compact disc (CD) technology shares some common features, including the 0.45 NA pick up head, 780 nm laser diode wavelength, 650 Mbyte storage capacity, 120 mm/80 mm disc diameter and etc. The physical specifications for all the newly developed logical formats such as VCD, S-VCD, CDDA, CD-ROM have been established by “Philips” and “Sony” based on a 0.45 NA pick up system. The compact disc (CD) technology opens not only the optical storage market but also a technical and industrial platform for developing higher storage capacity discs. The DVD family of products is an example and extension of the CD family of products.

In other words, the capacity of compact disc (VCD, CD-ROM, S-VCD, Photo-CD, CVD) has been limited to 650 Mbyte by “Philips” and “Sony” Standard Books. This equivalents to 74 minutes recording time for CD-Audio and VCD and about 40 minutes recording time for S-VCD. This prevents the market penetration of the Video Disc Recorder. As to extend the life of the traditional 780 nm optical pick up, an extended-play-time disc format is proposed based on the existing 780 nm wavelength, 0.5 NA pick up for optical disc.

Accordingly, the conventional compact disc formats and discs are suffered from the following drawbacks.

First, the relatively small storage capacity limits the market growth for the Video Disc Recorder for replacing the traditional Video Cassette Recorder.

Second, the conventional compact disc format takes two discs to store a 90 minutes Video program in MPEG1 VCD quality and more discs to store it in MPEGII S-VCD quality.

The barrier for capacity extension of the traditional compact disc is both physical and logical related.

A Logical Format is a protocol in which the hardware can signify the disc and activates a servo control loop for reading and writing. The coding method in the format includes the necessary information for addressing, identity and drive control. In the traditional time addressing format, all digits are represented in Binary Coded Decimal (BCD), including a Minutes field, a Second field and a Frame field, i.e. representing in Minutes:Second:Frame as a video recorder. It employs a total of 24 bits to represent the time address, wherein four are used for each digit. 75 frames are presented in one second and 60 seconds are presented in one minute. However, the definition is difficult to those in the other inventions. The BCD in the traditional time addressing format limits the maximum addressable time to 99:59:74.

According to the applications of the “Philips/Sony” CD-RW, the conventional address coding method allows the disc address of up to 700 Mbyte or “79 minutes:59 seconds:74 frames” without providing any method for further addressing. For the BCD coding method wherein an hour field is inserted, the time address can virtually be extend to 99 hours:99 minutes:59 seconds:74 frames. But this will mean a total given up of the existing industry platform and create a totally new format. Moreover, both new hardware, manufacturing system are required.

### SUMMARY OF THE PRESENT INVENTION

It is an objective of the present invention is to provide a hexadecimal/binary-coded-decimal (HEXA-BCD) hybrid address coding method which improves the existing addressing method without changing the hardware design and allows a recorder to extend the recording time code from 99:59:74 to 159:59:74.

Another objective of the HEXA-BCD hybrid address coding method according to the present invention is to enable the timing address of a blank media (AVCD), in an application of video recorder, to modulate into a 22.05 KHz wobble signal which makes tracking grooves on the media.

Another objective of the HEXA-BCD hybrid address coding method according to the present invention is to modulate into the data bit stream for a recorded media, depending on the format the media.

Another objective of the present invention to provide a HEXA-BCD hybrid address coding method for representing digital timing address of an audio/visual compact disc (AVCD), which is an extension to the “Philips-Sony” Standards, wherein the capacity of the AVCD is maximized to 1240 Mbyte which equivalents to 141 minutes of VCD recording time while accommodating the disc and the Servo Firmware without changing the pickup and writing strategy and giving up of the existing industry platform.

Accordingly, in order to accomplish the above objectives, the present invention provides a hexadecimal/binary-coded-decimal (HEXA-BCD) hybrid address coding method for representing digital timing address of data storage device, wherein the first digit of the minute filed is represented in Hexadecimal format with four binary data bits, therefore the 0-9 is the same as the BCD coding while 11-15 (A-F) is an extension which allows the proprietary recorder to recognize the data storage device and generates the time address for the digital data storage device. Furthermore, a slight fireware change is made by extending the address look up table to 159:59:74. Hence the first digit of the time address must be represented in Hexadecimal which fully utilize the four addressing bits in the M1 frame.

### BRIEF DESCRIPTION OF THE DRAWINGS

FIG. 1 is a block diagram illustrating an address coding method for data storage device according to a preferred embodiment of the present invention.

### DETAILED DESCRIPTION OF THE PREFERRED EMBODIMENT

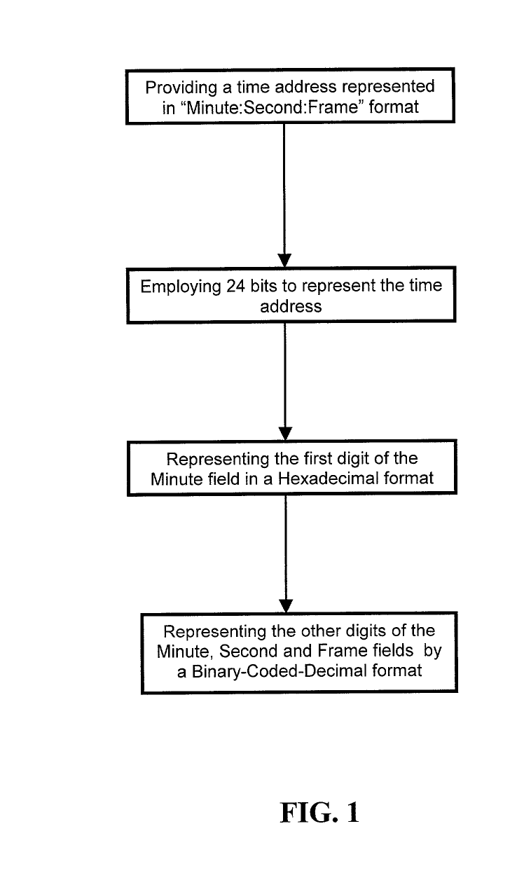

Referring to FIG. 1, the present invention provides a hexadecimal/binary-coded-decimal (HEXA-BCD) hybrid address coding method for representing digital timing address, such as audio/visual data addressing, of data storage device like rewritable or recordable optical disc, i.e. AVRW disc, adapted to be formatted as a VCD, S-VCD, CDDA, CD-ROM. AVRW-CD of the present invention is a removable and rewritable optical disc intended for AV data storage even though it is not limited for the AV data storage. It is a blank media serving the purpose similar to a piece of white paper with pre-printed writing guidelines. As to simplify the hardware design and make the hardware easier compatible with the market available recordable discs. The AVRW disc uses the same set of address location as the “Philips/Sony” CD-RW specifications with some additional parameters, a different time coding method and parameter definition.

According to the present invention, the recording time of the audio/visual optical disc can be lengthened through adjusting the logical format which is a protocol in which the hardware can signify the optical disc and activate a servo control loop for reading and rewriting. The coding method in the format includes the necessary information for addressing, identity and drive control. According to the present invention, the address is represented in Minutes:Second:Frame as a video recorder.

As mentioned in the background of the present invention, in the traditional time addressing format, all digits are represented in Binary Coded Decimal (BCD) which limits the maximum addressable time to 99:59:74. In other words, the maximum recordable and readable time address based on the existing industry platform is below 100 minutes. In the applications of the “Philips/Sony” CD-RW, it has been further limited to 79 minutes:59 seconds:74 frames, i.e. below 80 minutes.

According to the present invention, the address coding method for data storage device, comprising the steps of:

(a) providing a time address containing a Minute field, a Second field and a Frame field which are represented in “Minute:Second:Frame” format, wherein 75 frames are presented in one second and 60 seconds are presented in one minute, and each of the Minute field, Second field and Frame field contains a first digit and a second digit;

(b) employing 24 bits to represent the time address wherein four bits are used for each of the first digit and the second digit of the Minute field, Second field and Frame field;

(d) representing the first digit of the Minute field in a Hexadecimal format with four binary data bits; and

(e) representing the second digit of the Minute field, the first and second digits of the Second field and the first and second digits of the frame field by a Binary-Coded-Decimal format, thereby the time address is a hexadecimal/binary-coded-decimal hybrid address.

As to maintain the maximum compatibility with the traditional coding method, the innovative address coding method is preferred to be used for the audio/visual optical disc, wherein the first digit of the minute of the minute filed is represented in Hexadecimal format with four binary data bits. Hence the 0-9 is the same as BCD coding while 11-15 is an extension represented by “A, B, C, D, E, and F” which allow the existing proprietary recorder to recognize the optical disc and generate the time address for the digital optical disc.

In the hexadecimal-BCD format of the present invention, the time address can be represented as:

M1M2:S1S2:F1F2 wherein

M1 is represented in Hexadecimal format (0, 1, 2, 3, 4, 5, 6, 7, 8, 9, A, B, C, D, E, F), which fully utilize the four addressing bits in the M1 frame;

M2, S1S2, F1F2 are represented in Binary Coded Decimal format (0-9).

For example:

Address, 56 minutes:37 seconds:72 frames are represented by three data bytes (24 bits):

0101 0110 0011 0111 0111 0010

One example of the application is the Video Disc Recorder, wherein a AV-RW optical disc according to the present invention with dimension of 130 mm diameter can store up to 159 minutes 59 seconds and 74 frames of video program in MPEG 1 VCD format and hence the maximum time address is

| Field | M1 | M2 | S1 | S2 | F1 | F2 |
|---|---|---|---|---|---|---|
| Decimal | 15 | 9 | 5 | 9 | 7 | 4 |
| HEXA-BCD | 1111 | 1001 | 0101 | 1001 | 0111 | 0100 |

When recording, the time code is generated by a CPU system continuously with a look up table and registered in a media depending on applications. One can use bi-phase FM modulation to incorporate the address in a wobbie signal for groove generation in a blank media stamper or multiplexed with user data prior to the digital EFM signal generation in read-only disc stamper. A commercial video disc recorder can also generate the time code during recording and transformed in into pits and lands on the recordable optical disc of the present invention.

Accordingly, the recording time code can be extended from 99:59:74 to 159:59:74. In practical application, users may vary the recording time depending on application. For video recorder, the time address of a blank optical disc is modulated into a 22.05 KHz wobble signal which makes tracking grooves on the optical disc. In other words, the 24 bit time coding bit stream after inserting error correction codes can be modulated into the AV-RW recording groove by means of bi-phase frequency modulation wherein a carrier frequency of 22.05 KHz is used.

For a recorded media, it is modulated into the data bit stream depending on the format of the optical disc. In other words, the 24 bit time coding stream is multiplexed with the digital visual data and error correction codes prior to be converted into the serial EFM signal.

Groove recording is normally performed by means of the above described coding mode. However, in order to have more storage capacity, land recording is also possible after the groove has been fully recorded. In the land recording mode, the time code address has to add a constant offset which equals to the ending address of the groove recording. This further extends the capacity of the AVRW optical disc to 2.2 Gigabyte or 254 Minutes of MPEG-1 VCD quality program. Both the land and groove recording starts from the inner radius and a 10 second FIFO buffer is incorporated in the drive for groove/land switching. Tracking on land or groove can be achieved by inverting the servo of the Differential Phase Detector for tracking control. The starting time of the land recording is succeeding the end time of groove recording. A constant offset which equals to the end time address of the groove recording must be added in the drive firmware when decoding.

The addressing method will also allow the drive to address to each frame of a second. The digital timing data is modulated into the 22.05 KHz carrier to generate a wobble groove in the stamper. Other than AVRW, this addressing method can further be extended to the applications of read only AVCD, AVROM and the Write Once AVR.

In some specific sectors at the front of the AVRW, the timing information of the present invention is also used to communicate with the drive to inform the drive about the disc identity such as the total playtime, recording power, writing speed and etc. Such definition area presents at the beginning of the AV optical disc.

What is claimed is:

1. An address coding method for an optical disc, comprising the steps of:
providing a time address containing a Minute field, a Second field and a Frame field which are represented in “Minute:Second:Frame” format, wherein 75 frames are presented in one second and 60 seconds are presented in one minute, and each of said Minute field, Second field and Frame field contains a first digit and a second digit;
employing 24 bits to represent said time address wherein four bits are used for each of said first digit and said second digit of said Minute field, Second field and Frame field;
representing said first digit of said Minute field in a Hexadecimal format with four binary data bits; and
representing said second digit of said Minute field, said first and second digits of said Second field and said first and second digits of said frame field by a Binary-Coded-Decimal format, thereby said time address is a hexadecimal/binary-coded-decimal hybrid address.

2. The address coding method, as recited in claim 1, wherein when said first digit of said Minute field is between 0, 1, 2, 3, 4, 5, 6, 7, 8, and 9, said first digit of said Minute field is represented same as said Binary-Coded-Decimal format, wherein when said first digit of said Minute field is between 11, 12, 13, 14, and 15, said first digit of said Minute field is an extension represented by “A, B, C, D, E, and F” which allow an existing proprietary recorder to recognize said optical disc and generate said time address for said optical disc.

3. The address coding method, as recited in claim 1, wherein in said hexadecimal-BCD format, said time address can be represented as “M1M2:S1S2:F1F2”, wherein M1 is represented in said Hexadecimal format (0, 1, 2, 3, 4, 5, 6, 7, 8, 9, A, B, C, D, E, F), which fully utilize said four addressing bits in said M1 frame, and said M2, S1, S2, F1, F2 are represented in said Binary Coded Decimal format (0, 1, 2, 3, 4, 5,6, 7, 8,9).

4. The address coding method, as recited in claim 1, wherein said address coding method is applied as a video disc recorder and said optical disc is a AV-RW optical disc having a diameter of 130 mm and a maximum data storing capacity of 159 minutes 59 seconds and 74 frames of a video program in a MPEG 1 VCD format.

5. The address coding method, as recited in claim 2, wherein said address coding method is applied as a video disc recorder and said optical disc is a AV-RW optical disc having a diameter of 130 mm and a maximum data storing capacity of 159 minutes 59 seconds and 74 frames of a video program in a MPEG 1 VCD format.

6. The address coding method, as recited in claim 3, wherein said address coding method is applied as a video disc recorder and said optical disc is a AV-RW optical disc having a diameter of 130 mm and a maximum data storing capacity of 159 minutes 59 seconds and 74 frames of a video program in a MPEG 1 VCD format.

7. The address coding method, as recited in claim 4, further comprising the step of incorporating said time address in a wobbie signal by using a bi-phase FM modulation for groove generation in a blank media stamper.

8. The address coding method, as recited in claim 5, further comprising the step of incorporating said time address in a wobbie signal by using a bi-phase FM modulation for groove generation in a blank media stamper.

9. The address coding method, as recited in claim 6, further comprising a step of incorporating said time address in a wobbie signal by using a bi-phase FM modulation for groove generation in a blank media stamper.

10. The address coding method, as recited in claim 4, further comprising a step of multiplexing with a user data prior to a digital EFM signal generation in read-only disc stamper.

11. The address coding method, as recited in claim 5, further comprising a step of multiplexing with a user data prior to a digital EFM signal generation in read-only disc stamper.

12. The address coding method, as recited in claim 6, further comprising a step of multiplexing with a user data prior to a digital EFM signal generation in read-only disc stamper.

13. The address coding method, as recited in claim 4, further comprising a step of modulating said time address of a blank optical disc into a 22.05 KHz wobble signal which makes tracking grooves on said optical disc.

14. The address coding method, as recited in claim 5, further comprising a step of modulating said time address of a blank optical disc into a 22.05 KHz wobble signal which makes tracking grooves on said optical disc.

15. The address coding method, as recited in claim 6, further comprising a step of modulating said time address of a blank optical disc into a 22.05 KHz wobble signal which makes tracking grooves on said optical disc.

16. The address coding method, as recited in claim 4, further comprising a step of multiplexing a 24 bit time coding stream with digital visual data and error correction codes prior to be converted into a serial EFM signal.

17. The address coding method, as recited in claim 5, further comprising a step of multiplexing a 24 bit time coding stream with digital visual data and error correction codes prior to be converted into a serial EFM signal.

18. The address coding method, as recited in claim 6, further comprising a step of multiplexing a 24 bit time coding stream with digital visual data and error correction codes prior to be converted into a serial EFM signal.
